(19) United States
(12) Patent Application Publication
(10) Pub. No.: US 2009/0050712 A1
(43) Pub. Date: Feb. 26, 2009

(54) SPRAYER CONNECTOR FOR A PAINT CONTAINER

(75) Inventors: Marc Vitantonio, South Russell, OH (US); Brian V. Sokol, Vermilion, OH (US); William E. Rabbitt, Solon, OH (US); Douglas E. Whitner, Chargin Falls, OH (US)

Correspondence Address: Fay Sharpe LLP, 1228 Euclid Avenue, 5th Floor, The Halle Building, Cleveland, OH, 44115-1843, US

(73) Assignee: Innovation Direct LLC

(21) Appl. No.: 12/196,509

(22) Filed: Aug. 22, 2008

Related U.S. Application Data
(60) Provisional application No. 60/966,067, filed on Aug. 24, 2007.

(51) Int. Cl. B05B 9/04

(52) U.S. Cl. 239/332

(57) ABSTRACT

An electric power sprayer that includes a housing and a mounting arrangement. The housing is designed to at least partially contain a pump and a discharge nozzle opening. The mounting arrangement is designed to be secured to a container. The pump can be a battery powered pump. The mounting arrangement can be designed to engage an undersurface of a lip of a container opening. The mounting arrangement can be designed to connect to a standard paint container. The mounting arrangement can include a sealing arrangement that is designed to form a liquid seal between the container and the mounting arrangement.

The present invention claims priority on U.S. Provisional Patent Application Ser. No. 60/966,067 filed Aug. 24, 2007 entitled “SPRAYER CONNECTOR FOR A PAINT CAN,” which is incorporated herein by reference.

The present invention is directed to sprayers, and more particularly to electric sprayers that are used to spray viscous or semi-viscous fluids such as cleaners, paints, stains, and the like.

### BACKGROUND OF THE INVENTION

There are many electric powered and air powered paint sprayers in the marketplace. In various types of painting applications, spray painting is desirable. For instance, larger areas to be painted can be quickly painted when using an electric powered and/or air powered paint sprayer. In addition, when high gloss finishes are to be applied, paint brushes can cause streaking of the paint, thus electric powered and/or air powered paint sprayers are generally used to apply such paints to minimize streaking.

One common brand of consumer paint sprayer is a line of electric paint sprayers offered by Wagner. The commercially available electric paint sprayers include a container that requires a user to pour paint into the container and then secure the container to the electric spray unit. The transfer of paint from the paint can to the sprayer container can be time consuming, messy, and just plan inconvenient. In addition, when the sprayer container is empty, the user is required to detach the container from the electric spray unit, refill the sprayer container, and then reconnect the sprayer container to the electric spray unit. Such an operation is also time consuming, messy, and inconvenient. After the user is finished using the electric paint sprayer, the user must clean all of the components of the electric paint sprayer, including the sprayer container, prior to storing the electric paint sprayer for later use. This cleaning process can be very difficult, time consuming, messy, and inconvenient. If the components are not properly cleaned, the electric paint sprayer can become damaged or inoperable. The commercially available electric powered paint sprayers are also powered by an electrical cord that must be plugged into an outlet or other type of electric power source. As such, a user cannot use these electric powered paint sprayers in remote locations that do not have electrical outlets or allow the user to easily use a portable electric power generator.

In view of the current state of the art regarding electric powered paint sprayers, there is a need for an electric paint sprayer that is more convenient to use, which reduces the amount of a potential mess that can be associated with electric powered paint sprayers, which can be used in a variety of locations, and which reduces the amount of cleanup required after using the paint sprayer.

### SUMMARY OF THE INVENTION

The present invention is directed to sprayers, particularly to electric sprayers that can be used to spray viscous and/or semi-viscous fluids such as, but not limited to, cleaners, paints, stains, and the like, and even more particularly to an electric powered sprayer that can be used to spray viscous fluids and/or semi-viscous fluids such as, but not limited to, cleaners, paints, stains, and the like. Although the electric powered sprayer is particularly useful in spraying viscous fluids and/or semi-viscous fluids, it can be appreciated that the electric powered sprayer can also be used to spray non-viscous fluids (e.g., water, glass cleaner, etc.).

In one non-limiting aspect of the present invention, the electric powered sprayer of the present invention is particularly designed for use with liquids that are more viscous than water (1×10⁻³ Pa·s). Generally, the electric powered sprayer of the present invention is designed for use with liquids that have a viscosity of at least about 2×10⁻³ Pa·s. In one non-limiting configuration of the electric powered sprayer of the present invention, the electric powered sprayer is designed for use with liquids that have a viscosity of about 2×10⁻³ Pa·s to about 1000×10⁻³ Pa·s. In another non-limiting configuration of the electric powered sprayer of the present invention, the electric powered sprayer is designed for use with liquids that have a viscosity of about 5×10⁻³ Pa·s to about 500×10⁻³ Pa·s. In still another non-limiting configuration of the electric powered sprayer of the present invention, the electric powered sprayer is designed for use with liquids that have a viscosity of about 5×10⁻³ Pa·s to about 300×10⁻³ Pa·s. Non-limiting examples of viscous liquids can be dispensed by the electric powered sprayer of the present invention include, but are not limited to, household cleaners, oil-based paints, latex-based paints, oil-based stains, latex-based stains, lubricants, liquid food products (e.g., ketchup, mustard, artificial butter, syrup, etc.). As can be appreciated, the electric powered sprayer of the present invention can be used to also or alternatively dispense liquids that have a viscosity of less that about 2×10⁻³ Pa·s (e.g., water, window cleaners, insecticides, weed killing agents, etc.).

In another and/or alternative non-limiting aspect of the present invention, the electric powered sprayer of the present invention is at least partially powered by a battery source that supplies current to an electric spray unit. The battery source can be rechargeable; however, this is not required. The battery source can be at least partially charged from an external DC power source and or AC power source; however, this is not required. The one or more batteries used in the battery source can be standard sized batteries (e.g., AAA, AA, A, C, D, 9-volt. etc.); however, this is not required. The battery source can be housed in a water resistant or waterproofhousing so as to protect the one or more batteries from damage from liquids; however, this is not required. The one or more batteries of the battery power source can be designed to be replaceable by a user; however, this is not required. The battery power source can be designed to be charged by use of power cord that is designed to be connected to a power source (e.g., cigarette lighter, etc.), power generator and/or wall outlet; however, this is not required. The battery power source can be designed to be charged by use of a wireless charger; however, this is not required.

In still another and/or alternative non-limiting aspect of the present invention, the electric powered sprayer of the present invention includes an electric spray unit that is similar to the electric spray units disclosed in U.S. Pat. Nos. 4,154,375; 5,150,841; 5,716,007; and 7,318,539, and in any of the prior art literature cited and/or disclosed in these patents. U.S. Pat. Nos. 4,154,375; 5,150,841; 5,716,007; and 7,318,539, and all of the prior art literature cited and disclosed in these patents are incorporated herein by reference. As such, the particular operation, internal components and configuration of these electric spray units will not be discussed in detail herein.

In yet another and/or alternative non-limiting aspect of the present invention, there is provided a mounting arrangement that enables an electric spray unit of the electric powered sprayer of the present invention to be secured to a container that includes a liquid to be sprayed by the electric spray unit. The mounting arrangement is designed to be secured to a container that includes a liquid without having to transfer the liquid from one container to another container. For instance, the mounting arrangement in accordance with the present invention can be designed to connect to a standard paint container. In this non-limiting arrangement, the electric powered sprayer can be connected to a standard paint container and then use the paint container as the source of paint which is to be sprayed on a wall, floor, or any other surface by the electric spray unit. As a result, the need to transfer paint from the paint container to a container that is then connected to an electric powered sprayer, as required by prior art electric powered sprayers, is eliminated by the present invention. The use of the mounting arrangement of the present invention is thus a significant improvement over the current state of the prior art with regard to electric powered sprayers. The mounting arrangement of the present invention simplifies the use of electric powered sprayers, and reduces the mess, time and labor that was previously associated with transferring paint from one container to another container. Although the mounting arrangement of the present invention is particularly applicable for use with standard paint, stain or sealant containers (e.g., one cup container, one pint container, one quart container, one liter container, one gallon container, etc.); it can be appreciated that the mounting arrangement of the present invention can be used to secure the electric powered sprayer to other types of containers. Generally, the mounting arrangement of the present invention is designed to secure the electric powered sprayer to smaller containers so that the user can relatively easily lift the container and electric powered sprayer to spray a desired surface with the liquid in the container. As such, in one non-limiting arrangement, the mounting arrangement of the present invention is designed to secure the electric powered sprayer to containers that hold no more than about one gallon of liquid; however, it can be appreciated that the mounting arrangement of the present invention can be designed to secure the electric powered sprayer to containers that hold more than one gallon of liquid. Containers that hold more than one gallon of liquid can become very heavy and bulky, thus can impair the ability of the user to properly position and/or move the electric powered sprayer when applying a liquid to a surface.

In still yet another and/or alternative non-limiting aspect of the present invention, there is provided a mounting arrangement that enables an electric spray unit of the electric powered sprayer of the present invention to be releasably secured to containers that include liquid that is to be sprayed by the electric spray unit. In one non-limiting embodiment of the invention, the mounting arrangement includes a mechanical and/or electrical mechanism that enables a user to press a button, move a switch, move a lever, rotate one or more portions of the mounting arrangement and/or the like to cause the mounting arrangement to be secured to and/or released from a container. In one non-limiting arrangement, the mounting arrangement includes a mechanical lever that enables a user to manually connect and disconnect the mounting arrangement to a container such as, but not limited to, the top of a paint container.

In another and/or alternative non-limiting aspect of the present invention, there is provided a mounting arrangement that enables an electric spray unit of the electric powered sprayer of the present invention to form a liquid seal between the container and the electric spray unit so as to inhibit or prevent liquid in the container from spilling from the container once the mounting arrangement is secured to the container. In one non-limiting embodiment of the invention, the mounting arrangement generally includes one or more sealing rings and/or sealing surfaces that are used to form a liquid seal between the mounting arrangement and an opening in a container when the mounting arrangement is secured over the opening in the container. In another and/or alternative non-limiting embodiment of the invention, the mounting arrangement includes one or more moveable components that are designed to 1) clamp and/or engage onto an outer surface of the rim or opening and/or other outside surface of the body of the container, 2) clamp and/or engage with an inner surface of the rim or opening and/or other inside surface of the body of the container, and/or 3) clamp and/or engage with an underside of the rim or opening of the container. As can be appreciated, many different types and/or shapes of moveable components and/or many different mechanisms to cause movement of the one or more moveable components can be used to accomplish one or more of the three design objectives of the moveable components listed above.

In still another and/or alternative non-limiting aspect of the present invention, there is provided a mounting arrangement that includes a cover arrangement designed to seal and/or protect one or more components of the mounting arrangement from liquid in the container. The cover arrangement can include one or more seals, a rigid cover, a flexible cover, and/or the like. The cover arrangement can be used to facilitate in preventing liquids in the container from damaging and/or impairing the operation of the one or more components of the electric powered sprayer (e.g., motor, power source, switches, mounting arrangement, etc.).

In yet another and/or alternative non-limiting aspect of the present invention, the electric powered sprayer can be designed to include one or more disposable components. For instance, the electric spray unit and/or mounting arrangement of the electric powered sprayer can be designed to be disposable. The disposable design of one or more components of the electric powered sprayer eliminates the need of the user to clean or maintain one or more components of the electric powered sprayer after it has been used.

In one non-limiting object of the present invention, there is provided an electric powered sprayer having a mounting arrangement that can be directly connected to a container of liquid thereby eliminating the need to transfer liquids from one container to another container prior to the operation of the electric powered sprayer.

In another and/or alternative non-limiting object of the present invention, there is provided a battery powered electric powered sprayer having a mounting arrangement that can be directly connected to a container of liquid thereby eliminating the need to transfer liquids from one container to another container prior to the operation of the electric powered sprayer.

In still another and/or alternative non-limiting object of the present invention, there is provided a battery powered electric powered sprayer having a mounting arrangement that can be directly connected to a container of liquid thereby eliminating the need to transfer liquids from one container to another container prior to the operation of the electric powered sprayer.

In yet another and/or alternative non-limiting object of the present invention, there is provided an electric powered sprayer having a detachably connecting mounting arrangement that can be directly connected to a container of liquid thereby eliminating the need to transfer liquids from one container to another container prior to the operation of the electric powered sprayer.

In still yet another and/or alternative non-limiting object of the present invention, there is provided an electric powered sprayer having a mounting arrangement that can be directly connected to a standard paint container thereby eliminating the need to transfer paint from the paint container to another container prior to the operation of the electric powered sprayer.

In another and/or alternative non-limiting object of the present invention, there is provided an electric powered sprayer having a mounting arrangement that can form a seal between the mounting arrangement and the container to inhibit or prevent liquid from spilling from the container during the operation of the electric powered sprayer.

In still another and/or alternative non-limiting object of the present invention, there is provided an electric powered sprayer having a mounting arrangement that can be detachably connected to the housing of the electric spray unit of the electric powered sprayer.

In yet another and/or alternative non-limiting object of the present invention, there is provided an electric powered sprayer having a connecting mounting arrangement that includes a cover arrangement designed to seal and/or protect one or more components of the mounting arrangement from liquid in the container.

In still yet another and/or alternative non-limiting object of the present invention, there is provided an electric powered sprayer that includes a mounting arrangement that can be releasably connected to the housing of an electric spray unit of the electric powered sprayer.

In another and/or alternative non-limiting object of the present invention, there is provided an electric powered sprayer that is simple and easy to use.

In still another and/or alternative non-limiting object of the present invention, there is provided an electric powered sprayer that reduces incidences of spillage from a container containing a liquid.

In yet another and/or alternative non-limiting object of the present invention, there is provided an electric powered sprayer that can be manufactured for low cost.

In still yet another and/or alternative non-limiting object of the present invention, there is provided an electric powered sprayer that can be used in remote locations.

In another and/or alternative non-limiting object of the present invention, there is provided an electric powered sprayer that is disposable thereby eliminating the need for cleaning of the electric powered sprayer after use.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various preferred embodiments that the invention may take in physical form and in certain parts and arrangement of parts wherein:

FIG. 1 illustrates an elevation view of one non-limiting embodiment of an electric powered sprayer in accordance with the present invention that can be connected to different types of containers;

FIG. 2 illustrates an exploded view of one non-limiting configuration of a mounting arrangement in accordance with the present invention;

FIG. 3 illustrates a portion of a bottom side of the mounting arrangement of FIG. 1 in an unlocked position;

FIG. 4 illustrates a portion of a bottom side of the mounting arrangement of FIG. 1 in a locked position;

FIG. 5 is a partial cross-sectional view of a container and the electric powered sprayer connected to the container by the mounting arrangement of FIG. 2;

FIG. 6 illustrates an elevation view of another non-limiting embodiment of an electric powered sprayer in accordance with the present invention that can be connected to a container;

FIG. 7 illustrates a side view of the electric powered sprayer of FIG. 6 that is connected to a container;

FIG. 8 illustrates an exploded view of another non-limiting configuration of a mounting arrangement in accordance with the present invention;

FIG. 9 is a cross-sectional view of the mounting arrangement of FIG. 8 in an unlocked position; and,

FIG. 10 is a cross-sectional view of the mounting arrangement of FIG. 8 in a locked position on a container.

### DETAILED DESCRIPTION OF THE PREFERRED EMBODIMENT

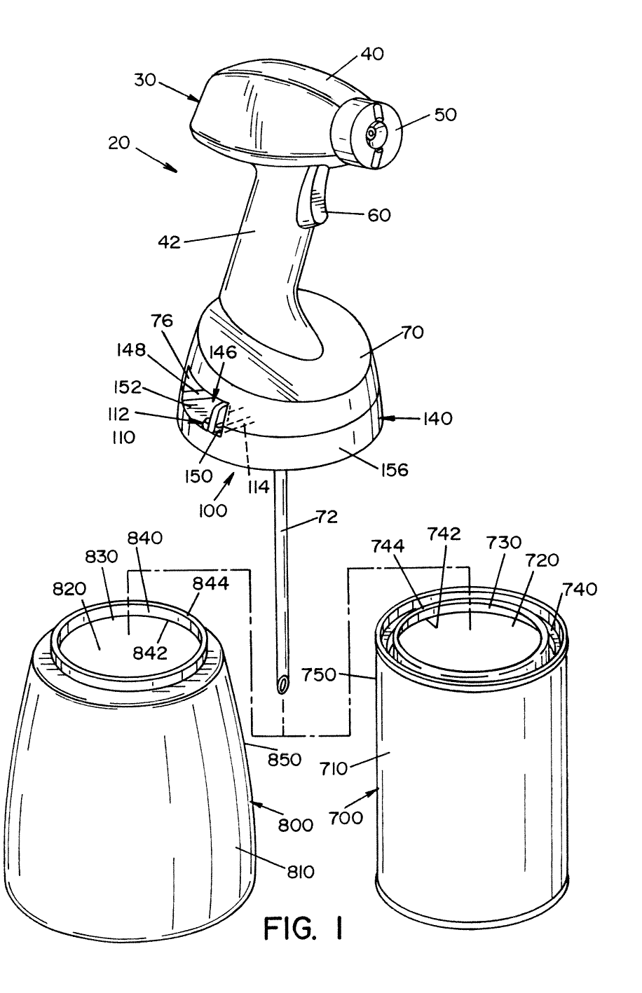

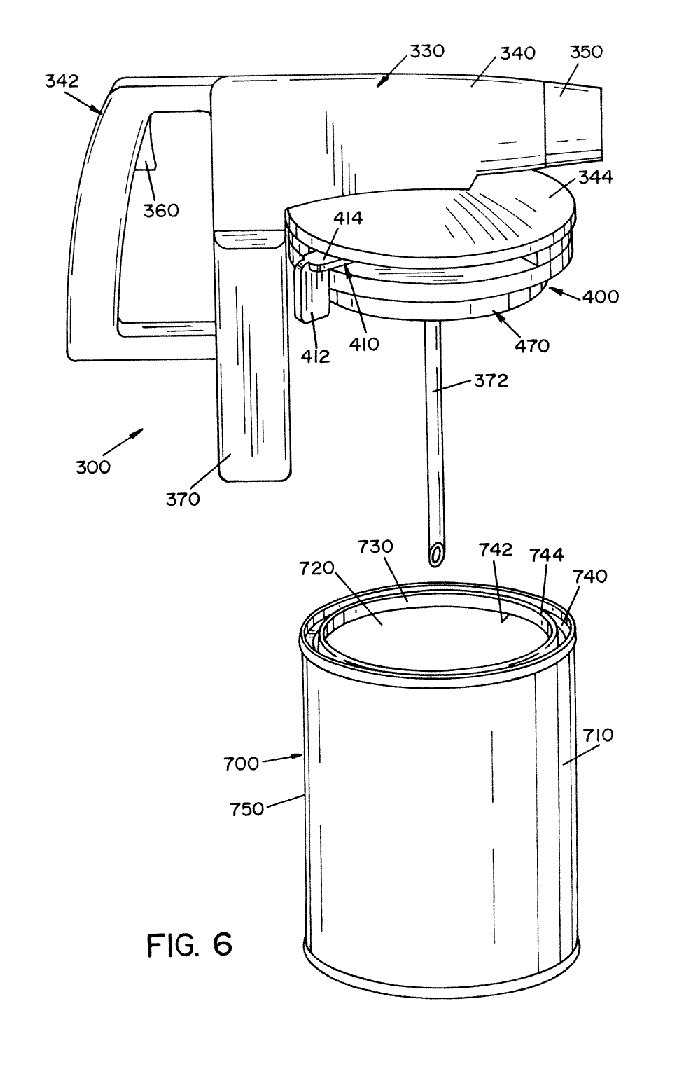

Referring now to the drawings wherein the showings are for the purpose of illustrating non-limiting embodiments of the invention only and not for the purpose of limiting same, FIGS. 1-5 illustrate one non-limiting embodiment of the present invention, and FIGS. 6-10 illustrate another non-limiting embodiment of the present invention.

Referring now to FIG. 1, one non-limiting embodiment of an electric powered sprayer 20 is illustrated. The electric powered sprayer 20 includes a housing 30. Positioned inside housing 30 is a pumping unit and a pump driving unit, now shown. The pumping unit and a pump driving unit can be the same as or similar to the pumping unit and a pump driving unit disclosed in U.S. Pat. Nos. 4,154,375; 5,150,841; 5,716,007; and 7,318,539, all of which are incorporated herein by reference. The housing 30 includes a contoured portion 40 that forms the spray head profile of the electric powered sprayer. A nozzle 50 is positioned at the end of the contoured portion 40. The nozzle 50 can be adjustable to form a desired spray pattern of fluid exiting from the nozzle; however, this is not required. Positioned below the contoured portion 40 is a handle portion 42. The handle portion 42 is designed to be gripped by a hand of a user when using the electric powered sprayer. The housing 30 includes a depressable switch 60 that is used by the user to operate the pumping unit and a pump driving unit of the electric powered sprayer 20. The switch is illustrated as positioned on the handle; however, it can be appreciated that the switch can be located on another location on body 20 (e.g., contoured portion). Typically, the electric powered sprayer includes one or more electric motors, not shown, that are powered by one or more batteries, not shown. As can be appreciated, the one or more electric motors can be at least partially powered by other or additional power sources; however, this is not required.

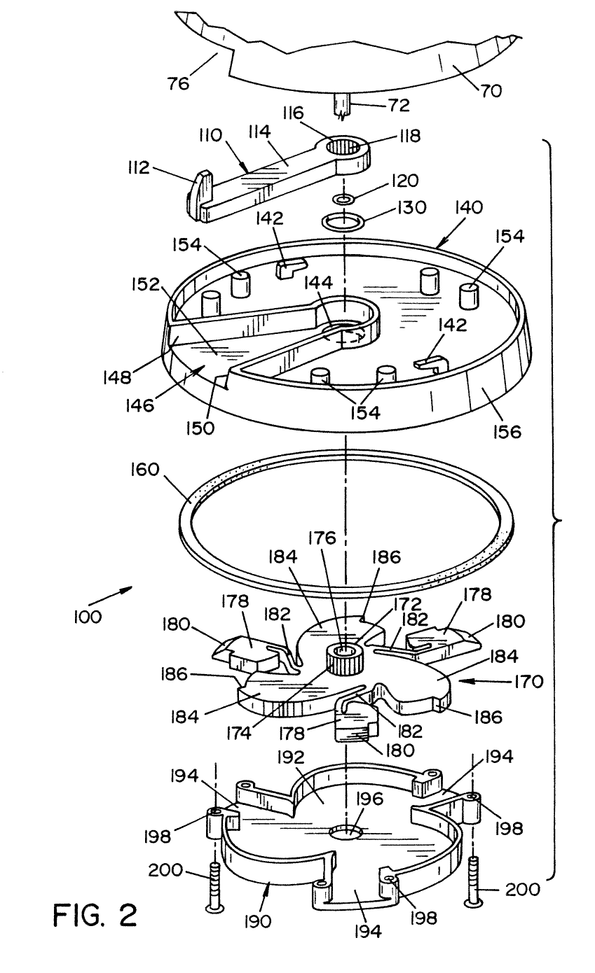

Formed in the bottom portion of housing 30 is a base 70 that is designed to at least partially house the components of the mounting arrangement or bayonet assembly 80 illustrated in detail in FIG. 2.

The shape of the housing of the electric powered electric sprayer 20 is non-limiting. As can be appreciated, base 70 can be detachably connected to the handle portion 42 of housing 30; however, this is not required. As illustrated in FIG. 1, base 70 is integrally formed with handle portion housing 20. The housing is generally formed of durable, lightweight materials (e.g., plastic, aluminum, etc.); however, this is not required.

Referring again to FIG. 1, the base 70 of the housing 30 is designed to be secured to a container 700 and/or 800. Container 700 is a standard paint container having a generally cylindrical body 710, an internal cavity 720 and a top opening 730 of cavity 720. Positioned about top opening 730 is a lip 740. Lip 740 includes an underside surface 742 and a top surface 744. The underside 742 of lip 740 extends to the side wall 750 of the container. The cavity of the paint container generally is about one pint; however, the cavity can have other volumes. For pint-sized paint containers, the inner diameter of top opening 730 is generally about 3.25 inches. Although container 700 has been referred to as a paint container, it can be appreciated that liquids other than paint can be included in container 700 such as, but not limited to, stains, sealants, varnishes, etc.

Container 800 is a more modern style paint container that is generally molded from plastic. Container 800 has a tapering body 810, an internal cavity 820 and a top opening 830 of cavity 820. Positioned about top opening 830 is a lip 840. Lip 840 includes an underside surface 842 and a top surface 844. The underside 842 of lip 840 extends to the side wall 850 of the container. The cavity of the paint container generally is about one pint; however, the cavity can have other volumes. For pint-sized paint containers, the inner diameter of top opening 830 is generally about 3.25 inches. Although container 800 has been referred to as a paint container, it can be appreciated that liquids other than paint can be included in container 800 such as, but not limited to, stains, sealants, varnishes, etc.

The base 70 of housing 30 can be designed be permanently or removably secured to container 700 and/or 800. As illustrated in FIGS. 1-5, the base 70 of housing 30 is designed to be removably connected to container 700 and/or 800. This type of connection can be used to enable a) one or more components of electric powered electric sprayer 20 to be cleaned and/or serviced after being removed from container 700 and/or 800, b) enable the electric powered electric sprayer 20 to be unsecured from one container and then secured to another container, c) enable the electric powered electric sprayer 20 to be unsecured from a container to allow the container to be refilled with a fluid and then allow the electric powered electric sprayer to be reconnected to the container, and/or d) enable the electric powered electric sprayer 20 to be unsecured from a container to allow the container to be sealed for disposal or for later use.

Referring now to FIG. 2, there is illustrated an exploded view of a mounting arrangement 100 that is designed to grip and/or form a seal with container 700 and/or 800. It will be appreciated that the mounting arrangement can be designed to grip and or form a seal with other size and/or shaped containers. The mounting arrangement 100 and/or base 70 of the housing are typically designed to inhibit or prevent paint, chemicals and or other types of liquids L in container 700 and/or 800 from damaging other parts of the electric powered sprayer 20; however, this is not required.

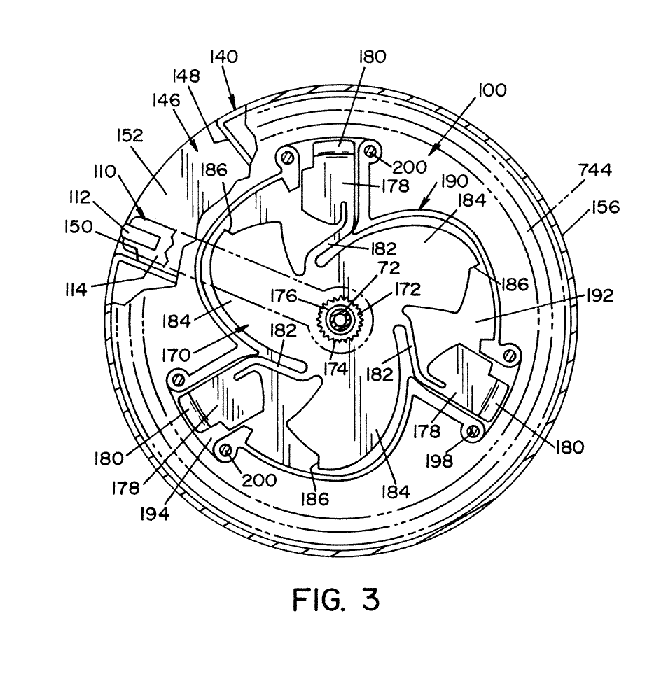

As illustrated in FIG. 2, the mounting arrangement 100 is formed by several components. The mounting arrangement includes a lever 110, a dip tube seal 120, a lever seal 130, a bayonet cover 140, mount seal 160, a bayonet 170, a bayonet retainer 190, and screws 200. Lever 110 is designed to enable a user to secure and unsecure the mounting arrangement to a container as illustrated in FIG. 3-5. Although not illustrated in FIG. 1, a portion of base 70 can include wording that informs a user of the locked and unlocked position of the lever 110; however, this is not required. Lever 110 can include a handle portion 112 that is connected to one end of a body 114 of the level; however, this is not required. The handle portion 112, when used, is designed to facilitate in the movement of the lever by a user; however, this is not required. Positioned at the opposite end of body 114 is an opening 116 that includes a plurality of gripping ribs 118. Opening 116 is of sufficient size to encircle dip tube 72 that extends from base 70. Dip tube 72 is fluidly connected to the pump mechanism, not shown, in housing 30. Gripping ribs 118 are designed to engage a portion of bayonet 170 as will be discussed below.

Dip tube seal 120 and a lever seal 130 are designed to form a fluid seal so as to inhibit or prevent fluid from entering between the bottom of base 70 and bayonet cover 140 when the bayonet cover is connected to base 70. Dip tube seal 120 is illustrated as small that lever seal 130. Dip tube seal 120 is designed to fit about dip tube 120. Lever seal 130 is designed to form a seal between lever 110 and bayonet cover 140. Dip tube seal 120 and a lever seal 130 are generally formed of a flexible elastomer material; however, this is not required.

Bayonet cover 140 is designed to be connected to the bottom of base 70 as illustrated in FIG. 1. Bayonet cover 140 includes one or more connectors 142 that are designed to secured the bayonet cover 140 to the bottom of base 70. As illustrated in FIG. 2, connectors 142 can be designed to enable a user to easily connect and disconnect bayonet cover 140 the bottom of base 70; however, this is not required. Connectors 142 can thus be designed to permanently connect or releasably connect bayonet cover 140 to the bottom of base 70. As can be appreciated, many other or additional connection arrangements can be used to connect bayonet cover 140 to the bottom of base 70.

Bayonet cover 140 includes a central opening 144 to enable dip tube 72 to pass therethrough. Bayonet cover 140 also includes a lever guide region 146 that includes two side walls 148, 150 that define the movement of the lever 110. Lever guide region 146 includes a recessed base 152 that is designed to be aligned with a raised portion 76 in base 70 when bayonet cover 140 is connected to the bottom of base 70 as illustrated in FIG. 1. Bayonet cover 140 also includes several screw hubs 154 that are designed to receive an end portion of screws 200 when bayonet retainer 190 is secured to bayonet cover 140 as described below.

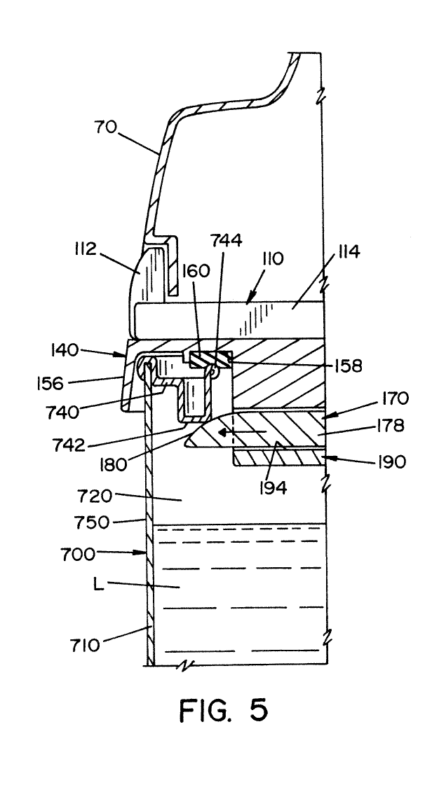

As illustrated in FIG. 5, the outer rim 156 of bayonet cover 140 is sized to enable the outer rim to fit about the top of container 700 as illustrated in FIG. 5. The underside of bayonet cover 140 includes a seal groove 158 that is designed to receive and maintain a portion of mount seal 160 in bayonet cover 140. As can be appreciated, seal groove is not required. Mount seal 160 can be secured to bayonet cover 140 by a friction engagement and/or by adhesive or the like. The size and position of mount seal 160 on bayonet cover 140 is selected so that when base 70 is positioned on top of a container, the mount seal 160 engages the top surface 744, 844 of container 700, 800 to forms a liquid seal between bayonet cover 140 and the container as illustrated in FIG. 5. Mount seal 160 is generally form of a flexible elastomer material; however, this is not required.

Referring again to FIG. 2, bayonet 170 includes a central raised hub 172 that includes a plurality of ribs 174 on the outer surface of the hub and central opening 176. Raised hub 172 has a size and shape to fit through opening 144 of bayonet cover 140. Lever seal 130 is designed to fit about central raised hub 172 when the hub is inserted through opening 144. Ribs 174 are designed to mate with ribs 118 in opening 116 of lever 110. Central opening 176 is designed to allow dip tube 72 to pass therethrough.

Bayonet 170 also includes a plurality of wedge members 178. The front edge of the three wedge members includes a slope surface 180. Each of the wedge members is connected to the body of bayonet 170 by a flexible arm 182. Positioned adjacent to each wedge member is an angular portion 184; however, this is not required. Each of the angular portions includes a stop surface 186.

Bayonet 170 is rotatably secured between bayonet cover 140 and bayonet retainer 190. Bayonet retainer 190 includes a cavity 192 that is designed to receive bayonet 170. Bayonet retainer 190 includes a plurality of wedge slots 194 that are designed to receive at least a portion of wedge member 178 of bayonet 170. Bayonet retainer 190 also includes a central opening 196 that is designed to allow dip tube 72 to pass therethrough. Bayonet retainer 190 also includes a plurality of fastener openings 198 to enable screws 200 to partially pass through the openings and be secured to screw hubs 154 of bayonet cover 140.

The operation of mounting arrangement 100 will now be described with reference to FIGS. 3-5. As mentioned above, base 70 is secured and unsecured to a container via mounting arrangement 100 by the movement of level 110 between a locked and unlocked position. As illustrated in FIG. 3, lever 110 is positioned in the unlocked position. In this position, wedge members 178 of bayonet 170 are in a retracted position in wedge slots 194 of bayonet retainer 190. When wedge members 178 are in the retracted position, outer rim 156 of bayonet cover 140 can be fitted about the top of a container.

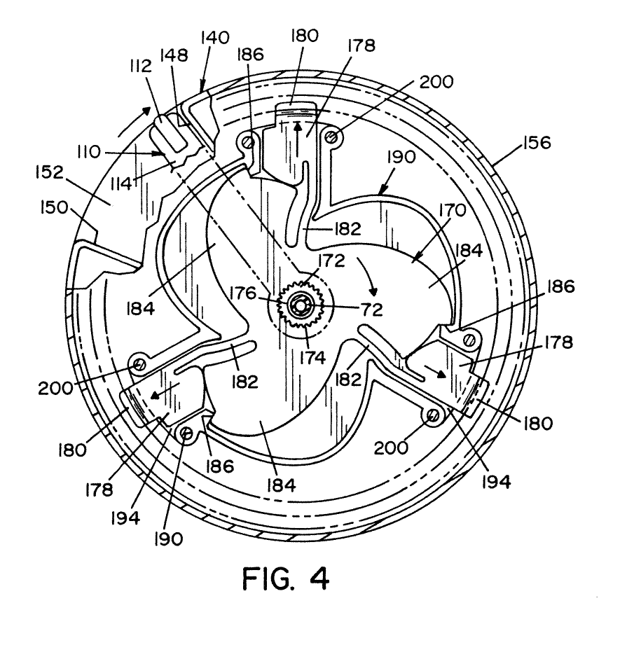

Once base 70 is positioned on the container, the user moves lever 110 to the locked positioned as indicated by the arrow in FIG. 4. When lever 110 is moved to the locked position, the movement of lever 110 causes bayonet 170 to rotate as illustrated by the arrows in FIG. 4 since bayonet 170 is connected to lever 110 via ribs 118, 172. As bayonet 170 rotates, the wedge members 178 move from a retracted position to an extended position in wedge slots 194 of bayonet retainer 190. The wedge slots 194 cause the wedge members 178 to move outwardly from bayonet retainer 190. The flexible arms 182 cause the wedge members 178 to move between a retracted and extended position when the bayonet 170 is rotated by lever 110. As illustrated in FIG. 4, the limit of rotation of bayonet 170 can be defined by walls 148, 150 of bayonet cover 140 and/or by stop surface 186 on bayonet 170 engaging a surface on bayonet retainer 190. As also illustrated in FIG. 4 bayonet 170 can be designed such that a portion of angular portion 184 engages the rear of wedge slots 194 to facilitate in maintaining the wedge members 178 in the extended position as illustrated in FIG. 4.

As best shown in FIG. 5, when the wedge members 178 move to the extended position as illustrated by the arrow, the sloped surface 180 of wedge members 178 engages the underside surface 742 of lip 740 of container 700 thereby causing mount seal 160 to compress on top surface 744 of lip 740 to thereby form a liquid seal between the mounting arrangement 100 and container 700. When lever 110 is moved back to the unlocked position, the wedge members 178 retract from the underside surface 742 of lip 740 and release the mounting arrangement 100 from container 700. This mounting arrangement enables a user to simply remove the lid from a paint container, place the mounting arrangement of the electric powered sprayer 20 over the opening of the paint container, move the lever to the lock position to form a liquid seal between the paint container and the mounting arrangement, and then depress trigger or switch 60 to begin the paint spraying operation. When the paint container becomes empty of paint, the user simply moves the lever to the unlocked position, and then removes the empty paint container from the mounting arrangement. If further painting is required, a new container of paint can be simply connected to the electric powered sprayer 20 as described above. After the painting operation is completed, the electric powered sprayer can be disposed of or cleaned for later use.

Referring now to FIGS. 6-10, another non-limiting configuration of an electric powered sprayer 300 is illustrated. The electric powered sprayer 300 illustrated in FIGS. 6-10 has a smaller profile to form a more compact unit when connected to container 700 such as, but not limited to, a paint container. The electric powered sprayer 300 includes a housing 330. Positioned inside housing 330 is a pumping unit and a pump driving unit, now shown. The pumping unit and a pump driving unit can be the same as or similar to the pumping unit and a pump driving unit disclosed in U.S. Pat. Nos. 4,154,375; 5,150,841; 5,716,007; and 7,318,539, all of which are incorporated herein by reference. The housing 330 includes a contoured portion 340 that forms the spray head profile of the electric powered sprayer. A nozzle 350 is positioned at the end of the contoured portion 340. The nozzle 350 can be adjustable to form a desired spray pattern of fluid exiting from the nozzle; however, this is not required. Positioned rearwardly of the contoured portion 340 is a handle portion 342. The handle portion 342 is designed to be gripped by a hand of a user when using the electric powered sprayer. The housing 330 includes a depressable switch 360 that is used by the user to operate the pumping unit and a pump driving unit of the electric powered sprayer 300. The switch is illustrated as positioned on the handle; however, it can be appreciated that the switch can be located on other locations on housing 330. Typically, the electric powered sprayer includes one or more electric motors, not shown, that are powered by one or more batteries, not shown. As can be appreciated, the one or more electric motors can be at least partially powered by other or additional power sources; however, this is not required.

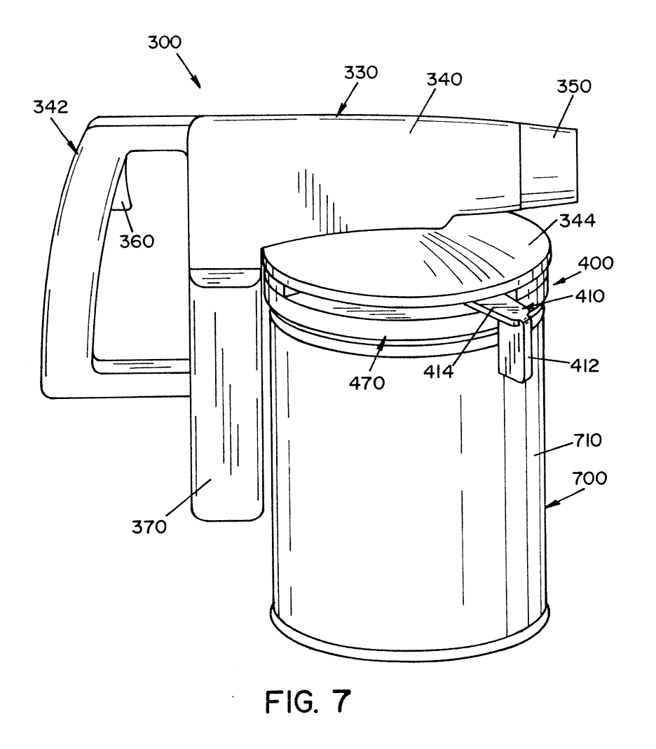

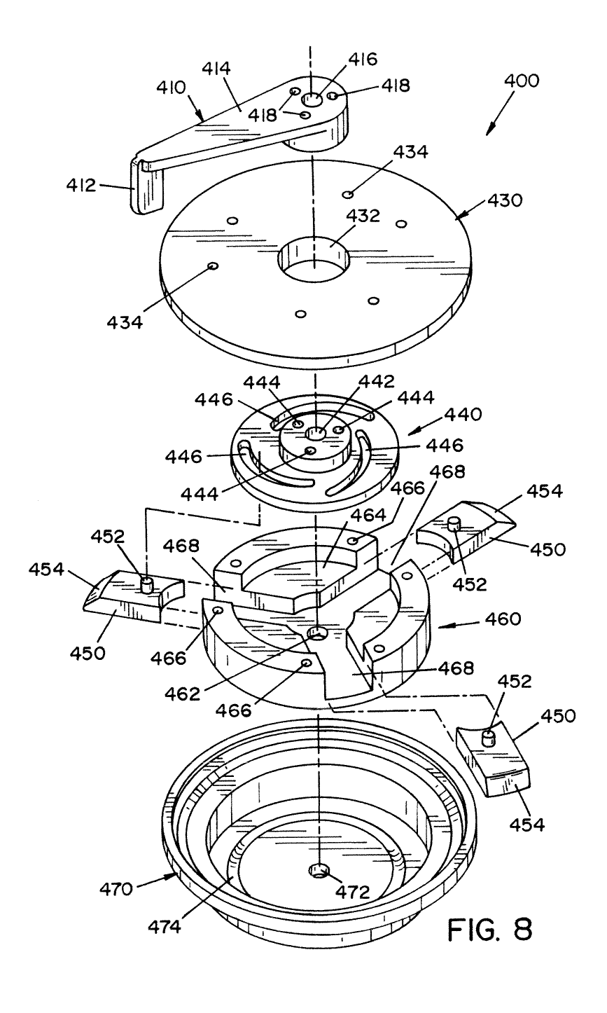

A bottom portion 370 of housing 30 is connected to the rear bottom of contoured portion 340. The bottom portion is designed in facilitating in positioning the electric powered sprayer 300 when connecting the electric powered sprayer to a container. The bottom portion can include an inner contoured surface 372 that can be used to at least partially conform to the outer curved surface of container 700; however, this is not required. A portion of handle 342 can also be connected to bottom portion 370 as illustrated in FIGS. 6 and 7; however, this is not required. Also positioned on the bottom of contoured portion 340 is a mount cap 344 that can be secured to a mounting arrangement 400. Mounting arrangement 400 can be permanently secured or releasably secured to mount cap 344. Mount cap 344 can be permanently secured or releasably secured to contoured portion 340. The mounting arrangement can have an assembly similar to the mounting arrangement illustrated in FIGS. 2-5 or as illustrated in FIGS. 8-10. As can be appreciated, the mounting arrangement illustrated in FIGS. 8-10 can be used in the electric powered sprayer illustrated in FIG. 1. As can be appreciated, the shape of the housing of the electric powered sprayer 300 is non-limiting. The housing of the electric powered sprayer 300 is generally formed of durable, lightweight materials (e.g., plastic, aluminum, etc.); however, this is not required.

As illustrated in FIG. 8, the mounting arrangement 400 is formed by several components. The mounting arrangement includes a lever 410 that is used to cause the mounting arrangement to grip and/or to form a seal with a container as illustrated in FIGS. 6 and 7. Although not illustrated in FIGS. 6 and 7, a portion of mount cap 344 can include wording that informs a user of the locked and unlocked position of the lever 410; however, this is not required. Lever 410 can include a handle portion 412 that is connected to one end of a body 414 of the level; however, this is not required. The handle portion 412, when used, is designed to facilitate in the movement of the lever by a user; however, this is not required. Positioned at the opposite end of body 414 is dip stick opening 416 and a plurality of pin opening 418 positioned about the dip stick opening. Dip stick opening 616 is of sufficiently size to encircle dip tube 372 that extends from mount cap 344. Dip tube 372 is fluidly connected to the pump mechanism, not shown, in housing 330. Pin openings 418 are designed to receive pins 420 or another type of connector (e.g., screw, etc.) that are used to secure a portion of lever 410 to bayonet 440 as will be discussed below.

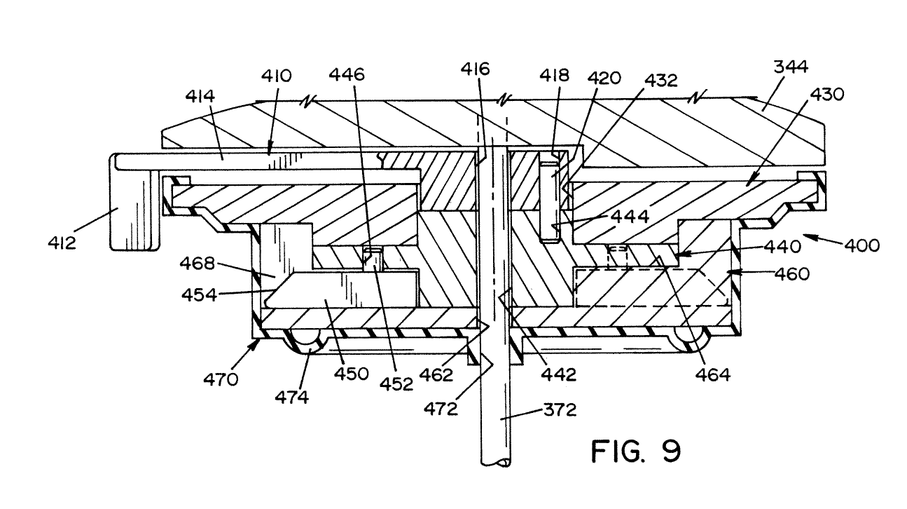

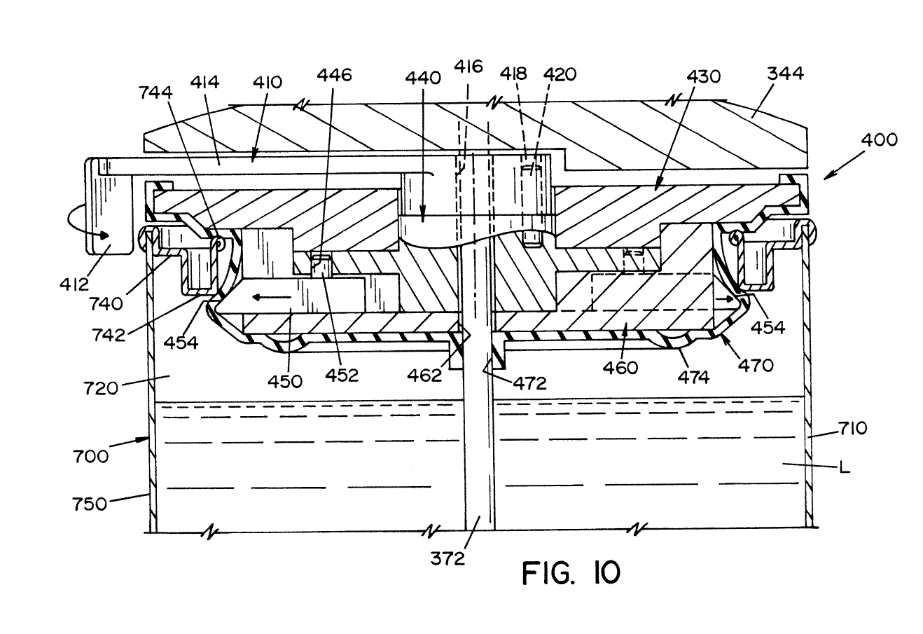

A bayonet cover 430 is positioned between lever 410 and bayonet 440. Bayonet cover 430 includes a central opening 432 that is designed to receive a portion of lever 410 as illustrated in FIGS. 9 and 10. As illustrated in FIG. 10, lever 410 is designed to rotate relative to bayonet cover 430 so that the lever can be moved between an unlocked and locked position. Central opening 432 also allows dip stick 372 to pass therethrough. Bayonet cover 430 also includes a plurality of pin openings that are used to receive a pin or other type of connector (e.g., screws, rivets, etc.), not shown, so as to connect the bayonet cover to bayonet retainer 460.

Bayonet 440 includes a central opening 442 to allow dip stick 372 to pass therethrough. Positioned about central opening 442 are a plurality of pin openings 444 that are designed to receive pins or other types of connectors (e.g., screws, rivets, etc.), not shown, so as to connect bayonet 440 to lever 410. Bayonet 440 also includes a plurality of slots 446 that vary in distance from the center of bayonet 440 when moving along the length of the slots. As will be described in more detail below, the orientation of the slots on bayonet 440 are designed to cause wedge legs 450 to move into and out of engagement with the lip of a container when lever 410 is moved by a user as will be discussed in more detail below.

Bayonet 440 is designed to be positioned between bayonet cover 430 and bayonet retainer 460 as illustrated in FIGS. 9 and 10. Bayonet retainer 460 includes a central opening 462 to allow dip stick 372 to pass therethrough. Bayonet retainer 460 also includes a cavity 464 that is designed to receive bayonet 440. Bayonet 440 is designed to rotate in cavity 464. Positioned about the outer portion of bayonet retainer 460 are a plurality of pin openings 466. The pin openings 466 are designed to receive pins or other types of connectors (e.g., screws, rivets, etc.), not shown, to connect bayonet retainer 460 to bayonet cover 430 to thereby entrap bayonet 440 between bayonet retainer 460 and bayonet cover 430. Bayonet retainer 460 includes a plurality of wedge slots 468 that are designed to each receive a wedge leg 450 and to guide the movement of the wedge leg 450 when a user moves lever 410 as will be described in more detail below.

Each wedge leg 450 includes a dowel projection 452 that is designed to be inserted into slot 446 in bayonet 440 as illustrated in FIGS. 8-10. As bayonet 440 rotates in bayonet retainer 460, the dowel projection 452 move within slot 446 thereby causing the wedge leg to move in a wedge slot 468. The top surface of the edge portion of the wedge leg includes a sloped surface 454.

A sealing boot 470 is used to cover and protect bayonet 440, wedge legs 450, and bayonet retainer 460 from the liquid in the container. Sealing boot 470 can be formed of a flexible material that facilitates in forming a liquid seal between the container and the bayonet cover 430 when the mounting arrangement is secured to the container as illustrated in FIG. 10. Sealing boot 470 includes an opening 472 to allow dip stick 372 to pass therethrough. Sealing boot can include a stretch groove 474 that enables the sealing boot to more easily stretch when the wedge legs move into engagement with the lip of the container as illustrated in FIG. 10; however, the use of stretch groove 474 is not required.

The operation of mounting arrangement 400 will now be described with reference to FIGS. 8-10. As mentioned above, mount cap 344 is secured and unsecured to a container via mounting arrangement 400 by the movement of level 410 between a locked and unlocked position. As illustrated in FIG. 9, lever 410 is positioned in the unlocked position. In this position, wedge legs 450 are in a retracted position in wedge slots 468 of bayonet retainer 460. When wedge legs 450 are in the retracted position, the bottom portion of the mounting arrangement can be inserted into or removed from the cavity opening of the container.

Once the mounting arrangement is at least partially positioned in the cavity of the container as illustrated in FIG. 10, the user moves lever 410 to the locked position as indicated by the arrow in FIG. 10. When lever 410 is moved to the locked position, the movement of lever 410 causes bayonet 440 to rotate since bayonet 440 is connected to lever 410 via pins 420. As bayonet 440 rotates, dowel projection 452 of each wedge leg move within slot 446 of bayonet 440 thereby causing the wedge leg to move in a wedge slot 468 and toward underside surface 742 of lip 740. The movement of the wedge legs toward lip 740 causes the sealing boot 470 to stretch as illustrated in FIG. 10. As can be appreciated, the limit of rotation of bayonet 440 is defined by the length of slots 446 of bayonet 440. As best shown in FIG. 10, when the wedge legs 450 move to the extended position as illustrated by the arrow, the sloped surface 454 of wedge legs 450 cause the sealing boot to engage the underside surface 742 of lip 740 of container 700 thereby causing the sealing boot to compress about lip 740 and form a seal with both the top surface 744 of lip 740 and the underside surface 742 of lip 740 as illustrated in FIG. 10. When lever 410 is moved back to the unlocked position, the wedge legs 450 retract from the underside surface 742 of lip 740 and release the mounting arrangement 400 from container 700. This mounting arrangement enables a user to simply remove the lid from a paint container, place the mounting arrangement of the electric powered sprayer 300 over the opening of the paint container, move the lever to the lock position to form a liquid seal between the paint container and the mounting arrangement, and then depress trigger or switch 660 to begin the paint spraying operation. When the paint container becomes empty of paint, the user simply moves the lever to the unlocked position, and then removes the empty paint container from the mounting arrangement. If further painting is required, a new container of paint can be simply connected to the electric powered sprayer 300 as described above. After the painting operation is completed, the electric powered sprayer can be disposed of or cleaned for later use.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

1. An electric power sprayer comprising a housing and a mounting arrangement, said housing designed to at least partially contain a pump and a discharge nozzle opening, said mounting arrangement designed to be secured to a container, said mounting arrangement including a clamping component designed clamp to a side of the container, clamp to a side surface of a container opening, clamp to an undersurface of a lip of a container opening, and combinations thereof.

2. The electric power sprayer as defined in claim 1, wherein said clamping system of said mounting arrangement is designed to engage said undersurface of a lip of a container opening.

3. The electric power sprayer as defined in claim 2, wherein said clamping system of said mounting arrangement includes an electric motor or manual lever to cause at least one component of said clamping system to move into engagement and to move out of engagement with said undersurface of a lip of a container opening.

4. The electric power sprayer as defined in claim 3, wherein said at least one component of said clamping system includes a plurality of sloped engagement surfaces designed to move into engagement and to move out of engagement with said undersurface of a lip of a container opening, at least two of said sloped engagement surfaces are spaced from one another.

5. The electric power sprayer as defined in claim 4, wherein said at least one component of said clamping system includes a plurality of sloped engagement surfaces designed to move into engagement and to move out of engagement with said undersurface of a lip of a container opening, at least two of said sloped engagement surfaces are spaced from one another.

6. The electric power sprayer as defined in claim 1, wherein said mounting arrangement includes a sealing arrangement to form a liquid seal between the container and said mounting arrangement.

7. The electric power sprayer as defined in claim 5, wherein said mounting arrangement includes a sealing arrangement to form a liquid seal between the container and said mounting arrangement.

8. The electric power sprayer as defined in claim 1, wherein said pump is a battery powered pump.

9. The electric power sprayer as defined in claim 1, wherein said pump is a battery powered pump.

10. The electric power sprayer as defined in claim 1, wherein said mounting arrangement is designed to connect to a standard paint container.

11. The electric power sprayer as defined in claim 9, wherein said mounting arrangement is designed to connect to a standard paint container.

12. A paint container and electric power sprayer assembly comprising a standard paint container and an electric power sprayer assembly that is designed to be releasably detachable to said standard paint container, said standard paint container designed to hold liquids that include paint, sealant, stain, paint remover liquids, stain remover liquids, and combination thereof, said standard paint container having a cavity that can hold at least 8 ounces of liquid and no more than about one gallon of liquid, said standard paint container including a cavity opening in a top of said standard paint container and a lip that extends from a side of said cavity opening to a side wall of said standard paint container, said electric power sprayer including a housing and a mounting arrangement, said housing designed to at least partially contain a pump and a discharge nozzle opening, said mounting arrangement designed to be releasably secured to said standard paint container, said mounting arrangement including a clamping component designed clamp to an undersurface of said lip of said standard paint container and to releasably engage from said undersurface of said lip of said standard paint container.

13. The paint container and electric power sprayer assembly as defined in claim 12, wherein said clamping system of said mounting arrangement includes an electric motor or manual lever to cause at least one component of said clamping system to move into engagement and to move out of engagement with said undersurface of said lip of said standard paint container.

14. The paint container and electric power sprayer assembly as defined in claim 12, wherein said at least one component of said clamping system includes a plurality of sloped engagement surfaces designed to move into engagement and to move out of engagement with said undersurface of said lip of said standard paint container, at least two of said sloped engagement surfaces spaced from one another.

15. The paint container and electric power sprayer assembly as defined in claim 13, wherein said at least one component of said clamping system includes a plurality of sloped engagement surfaces designed to move into engagement and to move out of engagement with said undersurface of said lip of said standard paint container, at least two of said sloped engagement surfaces spaced from one another.

16. The paint container and electric power sprayer assembly as defined in claim 12, wherein said mounting arrangement includes a sealing arrangement to form a liquid seal between standard paint container and the mounting arrangement.

17. The paint container and electric power sprayer assembly as defined in claim 15, wherein said mounting arrangement includes a sealing arrangement to form a liquid seal between standard paint container and the mounting arrangement.

18. The paint container and electric power sprayer assembly as defined in claim 12, wherein said pump is a battery powered pump.

19. The paint container and electric power sprayer assembly as defined in claim 17, wherein said pump is a battery powered pump.
